(19) United States
(12) Patent Application Publication
(10) Pub. No.: US 2008/0127036 A1
(43) Pub. Date: May 29, 2008

(54) Application development tool and related methods

(76) Inventors: Prashanth Kadur, Coram, NY (US); James Fagioli, Holtsville, NY (US)

Correspondence Address: FAY KAPLUN & MARCIN, LLP, 150 BROADWAY, SUITE 702, NEW YORK, NY, 10038, US

(21) Appl. No.: 11/581,967

(22) Filed: Oct. 16, 2006

(51) Int. Cl. G06F 9/44

(52) U.S. Cl. 717/100

(57) ABSTRACT

Described is an application development tool and related methods. The tool comprises an application development element for developing at least a portion of an application and a receiving element receiving hardware data of a target device on which the application will be executed. The application development element is reconfigured as a function of the hardware data.

### FIELD OF THE INVENTION

The present invention relates generally to application development tools and methods related thereto.

### BACKGROUND

A conventional software application development tool, such as an Integrated Development Environment (IDE), is a programming environment that includes components such as a graphical user interface (GUI) builder, a text/code editor, a compiler or interpreter and a debugger. Application developers use the components of the IDE to create software applications for computing devices. The components of the IDE are typically configured for computing devices having preidentified hardware components. For example, the GUI builder may be configured for a display screen with a size of 240×320. However, the application developer may be designing the application for a computing device with a display screen having a size of 320×240. When the application is launched on the computing device, portions of the GUI may not be shown on the display screen. That is, during the development process, the application developer may be unaware that the components of the IDE are not configured to reflect the hardware components of the computing device. Any attempt to reconfigure the components of the IDE to reflect the hardware components of the computing device may require the application developer to refer to reference documents, manufacturer technical support, etc. Thus, a significant amount of time may be wasted in correcting a developed application and/or manually reconfiguring the components of the IDE.

### SUMMARY OF THE INVENTION

The present invention relates to an application development tool and related methods. The tool comprises an application development element for developing at least a portion of an application and a receiving element receiving hardware data of a target device on which the application will be executed. The application development element is reconfigured as a function of the hardware data.

### DESCRIPTION OF THE DRAWINGS

FIG. 1 shows an exemplary embodiment of a system according to the present invention.

FIG. 2 shows an exemplary embodiment of a method according to the present invention.

FIG. 3a shows an exemplary embodiment of an IDE according to the present invention.

FIG. 3b shows an exemplary embodiment of an IDE reconfigured based on hardware data from a target device according to the present invention.

### DETAILED DESCRIPTION

The present invention may be further understood with reference to the following description and the appended drawings, wherein like elements are referred to with the same reference numerals. The present invention describes an application development tool and methods related thereto. In the exemplary embodiments, the application development tool detects hardware components of a computing device and the corresponding settings thereof. The application development tool then reconfigures itself based on the settings so that an interface of the application substantially reflects the computing device. While the exemplary embodiments are described with reference to generating an application for a mobile computing device, those of skill in the art will understand that the present invention may be used to design any type of software application for any type of computing device.

The exemplary embodiments of the present invention may be implemented as an IDE or as an extension to an existing IDE. In the latter case, the present invention may be provided as a plug-in, allowing the existing IDE to detect the hardware components of a computing device and the corresponding settings thereof. The plug-in may be one of a plurality of plug-ins provided in a software kit for use with the existing IDE.

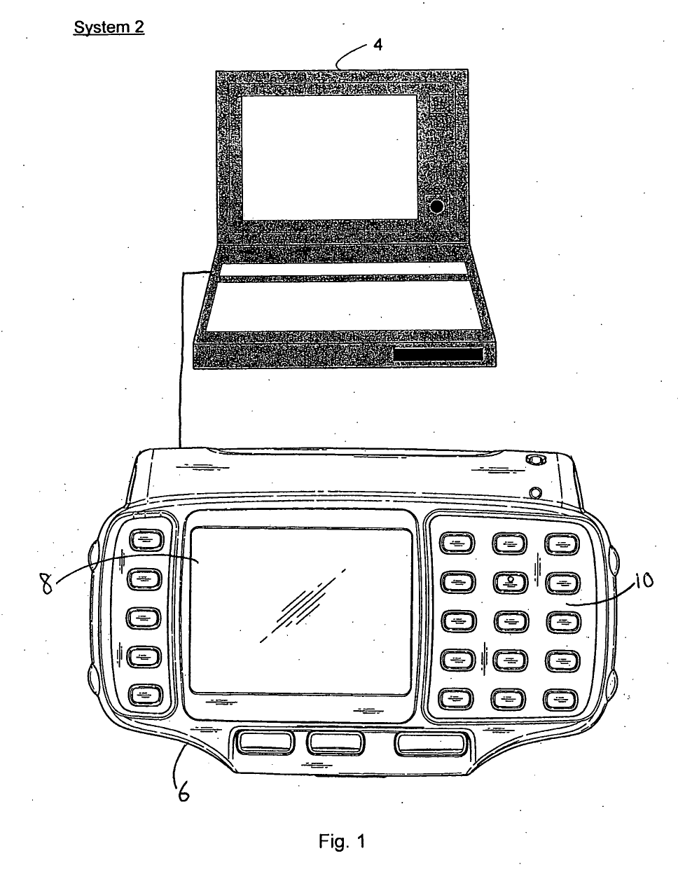

FIG. 1 shows an exemplary embodiment of a system 2 according to the present invention. The system 2 includes a host computing device 4 which is used to create a software application for a target computing device 6. The host device 4 may be a PC, laptop, tablet computer, etc. which uses an IDE or other application development software package to create the software application. The target device 6 may be a mobile computing device such as an imager-/laser-based scanner, an RFID reader, a mobile phone, a PDA, a tablet computer, a laptop, a digital camera, a portable media player, a smart appliance, etc. In other exemplary embodiments, the target device 6 may be a PC, a copier, a fax machine, a printer or other stationary workstation. The IDE provides a tool set including, for example, a graphical user interface (GUI) builder, a text/code editor, a compiler or interpreter and a debugger. The tool set of the IDE allows the application developer to construct, compile and debug the software application before being tested/implemented on the target device 6.

The IDE used by the host device 4 may provide a set of application development elements such as standard forms and tools. The standard forms may include (1) blank forms so that the developer can build the application from scratch, (2) templates for canned applications or application components and/or (3) completed applications for the developer to modify and/or customize. The standard tools are elements which, when inserted into one of the standard forms, provide a corresponding functionality for the application. For example, a standard data capture form may correspond to a set of input devices (e.g., a keypad, a keyboard, a touch screen, etc.) providing input data to the application. The developer selects the tool based on which one of the devices supplies the input data to the application. Thus, the IDE, as initially configured, may be used to create an application on a target device which includes one of the input devices. However, when the target device includes different hardware devices and/or hardware devices configured with different settings, the application may be incompatible with the target device.

The target device 6 may include several hardware components and/or settings thereof which are not supported by the IDE as initially configured. For example, the target device 6 may utilize an internal/external scanner, a laser-/imager-based scanner, an RFID reader, a display screen 8 having a predetermined size/layout/color, one or more user input components (e.g., a keypad 10, a trigger, etc.), speakers, wireless radio, network communication ports, etc. In addition, each of these hardware components may be configured to utilize default settings defined by the manufacturer of the target device 6, but the default settings may be adjusted depending on the application executed by the target device 6. Thus, it is beneficial for the IDE to have knowledge of the settings achievable by each of the hardware components.

In the exemplary embodiment, when the developer is creating an application, the target device 6 is coupled to the host device 4, and the IDE on the host device 4 detects hardware data of the target device 6 via a receiving element (e.g., software for a hard/soft port). The hardware data may include, but is not limited to, a list of hardware components, settings for the hardware components, a serial number for the target device 6 and/or each of the hardware components, a driver for operating each of the hardware components, etc. As will be explained further below, the IDE may reconfigure itself based on the hardware data to reflect the hardware components of the target device 6 and the corresponding settings.

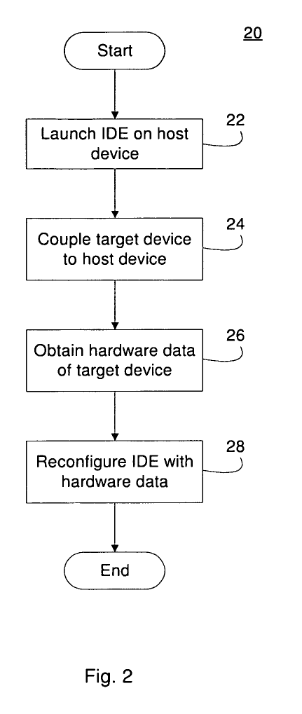

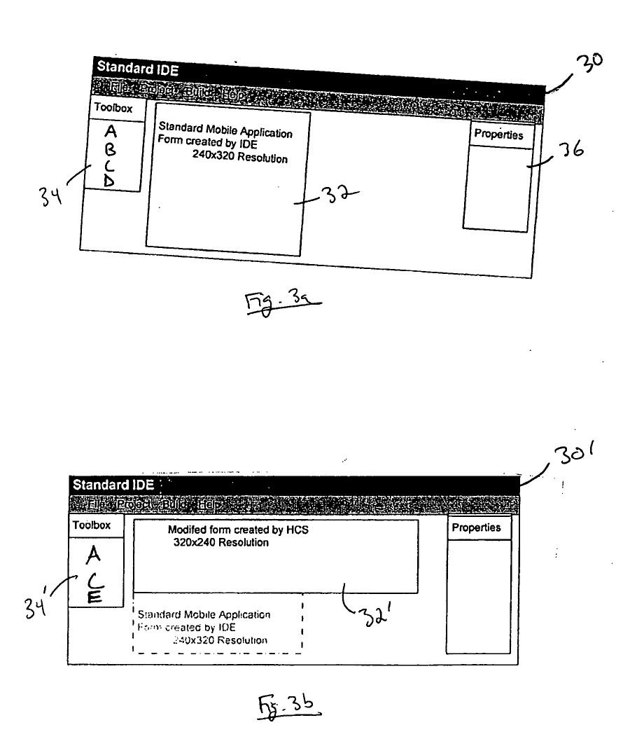

FIG. 2 shows an exemplary embodiment of a method 20 according to the present invention. In step 22, the IDE is launched on the host device 4. The IDE may be initially configured (e.g., by the manufacturer thereof) with first hardware data which corresponds to a predetermined set of hardware components, settings, serial numbers, drivers, etc. FIG. 3a shows an exemplary embodiment of an initial configuration of a graphical user interface (GUI) 30 of the IDE. The GUI 30 displays a toolbox 34, a form 32 and a properties window 36. The toolbox 34 includes tools (e.g., tools A-D) available to the developer which, as described above, may be inserted into the form 32 to provide a corresponding functionality to the application. The form 32 may be initially configured to a predetermined size (e.g., 240×320) which corresponds to an anticipated screen size of the target device 6. The properties window 36 may provide an updated list of functionalities provided by the application as it is developed, allowing the developer to confirm and refer back to functionality added to the application.

In step 24, the target device 6 is coupled to the host device 4 via a wired or wireless connection. As shown in FIG. 1, a cable (e.g., serial, USB, etc.) may interconnect respective ports on the host and target devices 4 and 6. In another exemplary embodiment, the host device 4 may establish a wireless connection with the target device 6 via, for example, wireless communication devices (e.g., Bluetooth® or IEEE 802.11 radios) in the host and target devices 4 and 6.

In step 26, the host device 4 obtains the hardware data of the target device 6. In the exemplary embodiment, the host device 4 downloads (or the target device 6 uploads) the hardware data over the wired or wireless connection. The host device 4 may include an application or applet for interrogating the target device 6 to which the target device 6 responds with a list of its hardware components. In another embodiment, the host device 4 may analyze a BIOS, OS and/or I/O ports of the target device 6 to determine the hardware data. In a further embodiment, the target device 6 may store the hardware data in memory (or other location/device) and transmit the data upon being connected to the host device 4.

In another exemplary embodiment, the target device 6 may include a barcode(s) and/or RFID tag which stores the hardware data. The host device 4 (or a data capture device coupled thereto) obtains the hardware data by decoding the barcode(s) and/or interrogating the RFID tag. As understood by those of skill in the art, in this embodiment, the host device 4 need not be coupled to the target device 6 and step 24 may be skipped. The barcode or tag may include identification data (e.g., the serial number) of the target device 6 which may be used to lookup the hardware data in a database. For example, the host device 4 may obtain the hardware data from a site (e.g., server, database, etc.) on a communications network (e.g., intranet, the Internet, etc.) using the identification data.

In step 28, the IDE is reconfigured based on the hardware data of the target device 6. As described above with reference to FIG. 3a, the GUI 30 of the IDE may be initially configured to the predetermined size of 240×320. However, as shown in FIG. 1, the display screen 8 utilizes a landscape layout with a size of 320×240. Thus, as shown in FIG. 3b, the IDE may adjust the GUI 30′ as a function of the hardware data from the target device 6 to generate a form 32′ in the landscape layout. In this manner, the developer may ensure that the form 32′ will be fully visible on the display screen 8. Working with the form 32′ in the correct size for the target device 6 may also enhance an aesthetic aspect and/or usability of the GUI of the application.

The IDE may also update the toolbox 34′ based on the hardware data by adding and/or removing tools. For example, if the hardware data indicates that the target device 6 includes an RFID reader, an RFID tool may be inserted into the toolbox 34. Conversely, if the toolbox 34 initially includes the RFID tool and the target device 6 does not include the RFID reader, the RFID tool may be removed from the toolbox 34. Alternatively, the RFID tool may be grayed (indicating that it should not be selected) or unselectable. Thus, in one exemplary embodiment, the IDE may only display to the user the tools which correspond to the hardware components of the target device 6, ensuring that the application is compatible therewith.

In other exemplary embodiments, the IDE may generate a response to a developer action based on the hardware data. For example, the target device 6 may include the keypad 10, but the display screen 8 may not be a touch screen. If the developer attempts to insert a touch screen tool from the toolbox 34′ into the form 32′, the IDE may output a warning message stating that a touch screen was not indicated by the hardware data and, thus, may not be included on the target device 6. optionally, the warning message may include an alternative suggestion to provide functionality similar to the touch screen. For example, the alternative suggestion may include highlighting a keypad tool in the toolbox 34′, because the hardware data indicated that the target device 6 included the keypad 10. Similarly, if the developer attempts to configure the form 32′ to display color images and the display screen 8 is monochrome, the IDE may provide the warning message and/or the alternative suggestion.

The hardware data obtained from the target device 6 may be used to generate a hardware profile thereof. The hardware profile may then be stored in a database (e.g., memory of the host device 4, an FTP site, a server, etc.) for subsequent use by the host device 4 or other host devices. For example, an application developer may search the database for the hardware profile of the target device 6 prior to connecting to and obtaining the hardware data directly from the target device 6. If the hardware profile is located in the database, it may be downloaded and used by the IDE to reconfigure itself with the hardware data therein. Thus, the developer may not be required to obtain the hardware data from the target device 6 when the hardware profile thereof is available in the database. In a further exemplary embodiment, the hardware data may be contained in a storage medium (e.g., floppy or zip disk, CD, DVD, memory stick, etc.) which, for example, comes packaged with the target device 6.

In a further exemplary embodiment, two or more hardware profiles may be combined to produce an application that is compatible with more than one target device. For example, two hardware profiles containing hardware data indicative of different size screens can be combined, allowing the IDE to recommend a window size that will fit the screen of both target devices. For example, if the two screen sizes are 320×320 pixels and 240×320 pixels, the IDE may set a screen size of 240×320 pixels as the default application window size.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An application development tool, comprising:
an application development element developing at least a portion of an application; and
a receiving element receiving hardware data of a target device on which the application will be executed,
wherein the application development element is reconfigured as a function of the hardware data.

2. The tool according to claim 1, wherein the hardware data is indicative of at least one hardware component of the target device.

3. The tool according to claim 2, wherein the at least one hardware component includes at least one of a laser-based barcode scanner, an imager-based barcode scanner, an image capture device, an RFID reader, a touch screen, a touch pad, a wheel input, a keypad, a keyboard, a microphone, a speaker, a trigger and a wireless communication radio.

4. The tool according to claim 1, wherein the application development element includes a form representing a graphical user interface of an application.

5. The tool according to claim 4, wherein the application development tool includes a toolbox including a plurality of tools which, when inserted into the form, provide a corresponding functionality for the application.

6. The tool according to claim 4, wherein the form is resized as a function of the hardware data.

7. The tool according to claim 4, wherein the form is resized to a size of a display screen of the target device.

8. The tool according to claim 5, wherein the tools in the toolbox are selected as a function of the hardware data.

9. The tool according to claim 8, wherein each of the selected tools corresponds to a respective hardware component of the target device.

10. A method, comprising:
storing an application development tool configured with first settings;
obtaining hardware data of a target device, the hardware data being indicative of hardware components of the target device;
reconfiguring the application development tool with second settings as a function of the hardware data and the first settings; and
displaying the reconfigured application development tool.

11. The method according to claim 10, wherein the first settings correspond to a first set of hardware components.

12. The method according to claim 11, further comprising:
comparing the first set of hardware components and the hardware data to generate the second settings.

13. The method according to claim 10, wherein the obtaining step includes:
establishing a wired connection with the target device; and
downloading the hardware data via the wired connection.

14. The method according to claim 10, wherein the obtaining step includes:
establishing a wireless connection with the target device; and
downloading the hardware data via the wireless connection.

15. The method according to claim 10, wherein the obtaining step includes:
downloading a profile of the target device from a database, the profile including the hardware data.

16. The method according to claim 10, wherein the hardware components include at least one of a laser-based barcode scanner, an imager-based barcode scanner, an image capture device, an RFID reader, a touch screen, a touch pad, a wheel input, a keypad, a keyboard, a microphone, a speaker, a trigger and a wireless communication radio.

17. A system, comprising:
a target device having a plurality of hardware components; and
a host device creating an application to be executed on the target device using an application development tool configured with first settings, the host device obtaining hardware data of the target device and reconfiguring the application development tool with second settings as a function of the first settings and the hardware data.

18. The system according to claim 17, wherein the first settings correspond to a first set of hardware components.

19. The system according to claim 18, wherein the host device compares the first set of hardware components and the hardware data to generate the second settings.

20. The system according to claim 17, wherein the host device and the target device are communicatively coupled via a wired connection, and the hardware data is transferred over the wired connection.

21. The system according to claim 17, wherein the host device and the target device are communicatively coupled via a wireless connection, and the hardware data is transferred over the wireless connection.

22. The system according to claim 17, further comprising:
a database storing a plurality of profiles corresponding to a plurality of target devices, each profile including hardware data for a respective target device,
wherein the host device obtains a profile of the target device from the database, the profile including the hardware data.

23. The system according to claim 17, wherein the hardware components include at least one of a laser-based barcode scanner, an imager-based barcode scanner, an image capture device, an RFID reader, a touch screen, a touch pad, a wheel input, a keypad, a keyboard, a microphone, a speaker, a trigger and a wireless communication radio.

24. An application development tool, comprising:
an application development means for developing at least a portion of an application; and
a receiving means for receiving hardware data of a target device on which the application will be executed,
wherein the application development means is reconfigured as a function of the hardware data.
